(19) United States
(12) Patent Application Publication
(10) Pub. No.: US 2007/0148316 A1
(43) Pub. Date: Jun. 28, 2007

(54) Egg that is agitated with edible composition, method and device for manufacturing it

(76) Inventor: Hye-Jin Lee, Seoul (KR)

Correspondence Address: ROBERT E. BUSHNELL, 1522 K STREET NW, SUITE 300, WASHINGTON, DC, 20005-1202, US

(21) Appl. No.: 10/581,715

(22) PCT Filed: Dec. 2, 2004
(86) PCT No.: PCT/KR04/03149

§ 371 Date: Jun. 28, 2006

(30) Foreign Application Priority Data
Dec. 5, 2003 (KR) 10-2003-0088139
Mar. 30, 2004 (KR) 10-2004-0021790

(51) Int. Cl. A23L 1/32

(52) U.S. Cl. 426/614

(57) ABSTRACT

Disclosed herein is a processed raw egg, and a method of and apparatus for manufacturing the same, in which various edible compositions are added and mixed to a raw egg so that it can be served as a healthy food. The method comprises: a cleaning water and sterilizing for raw egg; a egg-shell drilling process; a edible composition injection process; a raw egg agitation process; and a well-done process. The apparatus for carrying out the method is also disclosed.

### TECHNICAL FIELD

The present invention relates to a processed raw egg having an edible composition agitated therewith, and a method of and apparatus for manufacturing the same, in which an edible compositions useful to the human body is injected into the inside of a raw egg and agitated inside of the raw egg, and the resultant raw egg can be boiled and steamed so as to intake, thereby serving as a nourishing meal or a healthy food.

### BACKGROUND ART

Generally, a raw egg is in-taken in a raw state or in a boiled state. At this time, due to the fishy smell inherent to the raw egg, mostly, people do not eat more than one or two eggs. In case of a boiled egg, the boiled yolk (the yellow of the egg) is not smooth so that people is prone to be reluctant to eat.

A method of smoking a chicken egg is disclosed in Korean Patent Laid-open Publication Nos. 2001-0003319, 1999-0073457, 2000-0030104, and 2001-0073241.

The smoked egg can be kept for a long time and in-taken, but it is smoked in such a way that a composition such as salt is permeated into the inside of the egg through micro-pores of the egg-shell. Therefore, the fishy smell of the chicken egg can be alleviated, but not completely removed. In addition, since nutrients necessary for the human body such as vitamin C, which hardly exists in chicken eggs, cannot be permeated adequately into the chicken egg, the method of smoking eggs merely adjusts the flavor thereof, or lengthens its effective date.

In addition, Korean Patent Laid-open. Publication No. 2001-0084617 discloses a method of adding externally additives to the content of a chicken egg. In this method, the raw chicken egg is dipped in the salt water and matured in order for salt to be permeated into the egg through micro-pores of the egg-shell. Therefore, it merely applies salt for seasoning, but not permeates useful nutrients into the egg.

On the other hand, Korean Patent Laid-open Publication No. 2000-0008062 discloses a method of permeating and mixing salt water or spices and condiments into the egg.

In the above method, however, a needle of a syringe is used to inject the additives, so that a mass production and thus commercialization is not easy, along with not being hygienic.

Moreover, the albumen and the yolk of the raw egg contains a lot of carbohydrate and is highly viscous so that the cohesive power between the albumen and the yolk is strong, thereby preventing the injected salt and nutrients from spreading over the whole area of the egg. From the result of experiments, it has been found out that the above-processed egg is not easy to in-take.

As a result of experiment according to the above prior art, i.e., when the raw chicken egg is rotated forwards and in a reverse direction in order to mix the albumen and the yolk, it has been found out as follows.

In other words, as a result of rotating in a forward direction a raw chicken egg at a low speed (60 rpm/min), intermediate speed, and high speed (500 rpm/min), it has been found out that the centrifugal force is applied identically to the egg-shell, and the contents of the egg, so that the albumen and the yolk are not mixed.

In addition, it seems that, when the raw chicken egg is rotated in a reverse direction while rotating in a forward direction, the contents of the egg will be mixed. However, a sliding action occurs only between the egg-shell and the contents thereof, but the yolk inside the albumen is not broken, so that they are not mixed. That is, at the moment when the egg is rotated in a revere direction while rotating a positive direction, the solid component, the egg-shell is rotated in a reverse direction instantaneously, but the liquid component, the contents of the egg responds slowly.

In consequence, the prior art injects salt or seasonings using a syringe into the egg, but the contents thereof is not mixed, thereby not being practical.

In another mixing method, dissimilar to the conventional technique where the raw egg is rotated in a circumferential direction thereof, the raw egg is reciprocated with a fast speed in a longitudinal direction of long axis of the egg, thereby mixing the contents of the egg, due to the air pocket (air layer) inside the raw egg.

In the above technique, when the raw egg is reciprocally moved until the contents of the egg are thoroughly mixed, the raw egg is rotten or becomes stale to the extent that it cannot be eaten.

Furthermore, although the raw egg does not become stale enough to eat, when the egg-shell is removed from a boiled egg by people who expect that the white of the egg will be exposed, it is likely to spoil his or her appetite. That is, since the mixed albumen and yolk appears to be stained, it has been found from the experiments that the outer appearance lowers the appetite, which leads to a feeling of reluctance against eating.

### DISCLOSURE OF INVENTION

The present invention has been made in order to solve the above problems occurring in the art, and it is an object of the invention to provide a processed raw egg, and a method of and apparatus for manufacturing the same, in which various edible compositions are added and mixed to a raw egg including a chicken egg without not being stale, thereby eliminating the fishy smell inherent in raw eggs and enabling to be served as a healthy food.

Another object of the invention is to provide a processed raw egg, and a method of and apparatus for manufacturing the same, in which, when the egg-shell is removed from a well-done egg having an edible composition mixed therewith, the albumen is exposed in the same appearance as in the conventional well-done egg, thereby eliminating a feeling of reluctance in taking the egg.

A further object of the invention is to provide a raw egg having various colors, including a natural color of an edible composition added thereto, or a color of edible pigments.

A further object of the invention is to provide a raw egg having various aromas, including an aroma of an edible composition added thereto, or an aroma of various edible spices.

In order to accomplish the above object, according to one aspect of the invention, there is provided a method of manufacturing a processed raw egg having an edible composition agitated therewith. The method comprises: a) a cleaning and sterilizing step for cleaning an raw egg E with a cleaning water and sterilizing it; b) an egg-shell drilling step for forming an injection hole Ef in the upper portion of the egg-shell Ea of the raw egg E, wherein the raw egg E is fixedly erected and a certain pressure is exerted on the upper portion of the long axis of the raw egg by means of a drilling and injection tube 42 such that the injection hole is formed; c) an edible composition injection step for injecting a predetermined amount of edible composition P by penetrating the drilling and injection tube 42 inside the raw egg E through the injection hole Ef of the raw egg E; and d) a raw egg agitation step for agitating the edible composition P and the viscous albumen Eb and yolk Ed using an agitating means inserted through the injection hole Ef of the raw egg E.

According to another aspect of the invention, there is provided a method of manufacturing a processed raw egg having an edible composition agitated therewith. The method comprises: a) a cleaning and sterilizing process (a first step) for cleaning an raw egg with a cleaning water and sterilizing it with ozone; b) a solidified albumin skin layer forming process (a second step) for forming a solidified albumen skin layer having a thickness of 2˜3 mm, wherein the albumen inwards of the egg-shell is heated and solidified for 5˜8 minutes at 60˜65° C.; c) an egg-shell drilling process (a third step) for forming an injection hole in the egg-shell, wherein the raw egg is fixedly erected and a pressure of 3˜5 kg/cm² is exerted by means of a drilling and injection tube; d) an edible composition injection process (a fourth step) for injecting an edible composition within 10 volume % of the raw egg by penetrating the drilling and injection tube through the injection hole of the raw egg; e) a raw egg agitation process (a fifth step) for agitating the edible composition and the viscous albumen and yolk in such a manner that a support and axle rod having a rotating member provided in the outer peripheral thereof is inserted through the injection hole and the rotating member is spread and rotated; and f) a well-done process (a sixth step) for producing a well-done egg by providing a heat to the raw egg.

In addition, before the fourth step of injecting the edible composition, or instead of the fourth step, at least part of the yolk is removed by suction, and grains including rice, barley, brown rice, and glutinous rice is added and agitated. A chicken egg includes 8˜11 weight % of egg-shell, 27˜32 weight % of yolk, and 56˜61 weight % albumen. In case where the yolk is completely removed, it can provide a healthy food to people who do not like the yolk, or to whom the yolk having a lot of cholesterol is harmful. Also, since about 30% of the chicken egg can be replaced by grains, nutrients of grains including carbohydrate is added to the raw egg, thereby providing a more balanced nourishing meal.

Alternatively, at least part of the yolk remains, but part of or the entire of the yolk and/or the albumen can be removed. Instead, fruits can be injected and agitated in a powder form or in a liquid extract form, along with Calcium or an edible material containing Calcium (for example, diary product such as milk, bean, green vegetable, seaweed, fish bone), so that a raw egg pudding can be made by means of the inter-mixing of the fruit constituent, Calcium and the yolk.

According to another aspect of the invention, there is provided an apparatus for manufacturing a processed raw egg having an edible composition agitated therewith. The apparatus comprises: a) a raw egg holding means 30 including a resting groove 31 for an raw egg to be rested thereon and a pressurizer 35 for pressurizing one side of the raw egg E; b) a drilling and injection tube 42 for forming an injection hole Ef in the upper end portion of the raw egg E; c) a drilling and injection means 40 for injecting an edible composition P into the interior of the raw egg, the drilling and injection means including a quantified discharging pump 46 and the drilling and injection tube 42; and d) an agitating means 60 for agitating the internal material of the raw egg, the agitating means being injected in the form of a rod and afterwards spread, and moving upwards and downwards and/or rotating.

The apparatus of the invention may further comprise a suction pump and a suction tube, so that part of or the entire of the content of the raw egg including the albumen and the yolk is removed and instead grains or fruits can be added as much as the removed. In addition, instead of the suction pump, the quantified pump can be reverse-operated to thereby remove part of or the entire of the yolk.

According to another aspect of the invention, there is provided a processed raw egg having an edible composition agitated therewith. In the processed raw egg, a certain desired amount of edible composition is injected through an injection hole formed in the upper portion of the long axis of a raw egg, and the injected edible composition and the contents of the raw egg are agitated by an agitating means. The agitating means is inserted in the form of a rod, spread in a desired form, and moved inside the raw egg.

### BRIEF DESCRIPTION OF DRAWINGS

Further objects and advantages of the invention can be more fully understood from the following detailed description taken in conjunction with the accompanying drawings, in which:

FIG. 1 is a flow chart explaining a method of manufacturing an raw egg having an edible composition mixed inside thereof according to the invention; and

FIG. 2 illustrates schematically the first step of cleaning and sterilizing a raw egg in the method of the invention;

FIG. 3 illustrates schematically the second step of solidifying the albumen surface of a raw egg in the method of the invention;

FIG. 4 shows a cross-section of a raw egg processed by the second step of the invention;

FIG. 5 is a schematic view of an apparatus of the invention for carrying out the third and fourth steps of the method of the

FIG. 6 is a partially enlarge view of the egg-shell drilling and injection means according to the invention;

FIGS. 7 to 9 show the operation of the egg-shell drilling and injection means, which carries out the third and fourth steps of the invention;

FIG. 10 is a schematic view of an apparatus of the invention for carrying out the fifth step of the method of the invention;

FIG. 11 shows a cross-section taken along the line U-U′ in FIG. 10;

FIG. 12 is an enlarged view of the agitating means according to the invention;

FIG. 13 is an enlarged exploded view of a core portion of the agitating means of the invention;

FIG. 14 is an enlarged view of the portion V in FIG. 12;

FIG. 15 shows a cross-section taken along the line W-W′ in FIG. 12;

FIG. 16 shows an enlarged cross-section taken along the line X-X′ in FIG. 12;

FIG. 17 shows an enlarged cross-section taken along the line Y-Y′ in FIG. 12;

FIG. 18 shows an enlarged cross-section taken along the line Z-Z′ in FIG. 12; and

FIGS. 19 to 21 show the operation of the agitating means, which carries out the fifth step of the invention; and

FIG. 22 is a cross-section of a raw egg processed according to the invention.

### BEST MODE FOR CARRYING OUT THE INVENTION

The preferred embodiments of the present invention will be hereafter described in detail with reference to the accompanying drawings.

In the description, the term “raw egg” means an egg-cell that a female animal lays in vitro. The raw egg includes any egg-cell as long as it has an egg-shell, and a yolk and an albumen contained and divided inside the egg-shell. Preferably, the raw egg suitable for the invention includes a bird egg such as a chicken egg, a quail egg, a duck egg, and an ostrich egg, an unfertilized or fertilized reptile egg such as a turtle egg and an alligator egg.

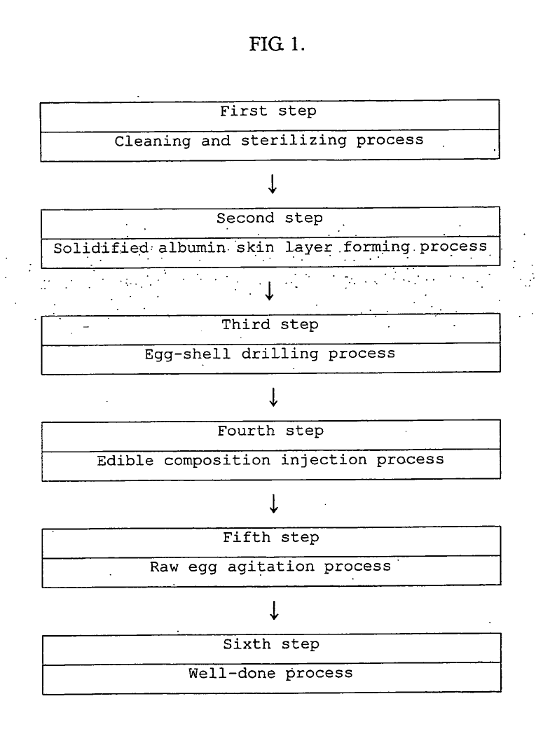

FIG. 1 is a flow chart showing the procedure of manufacturing a raw egg having an edible composition mixed inside thereof. In the first step in the manufacturing method of the invention, an egg having a high freshness is selected, cleaned, and sterilized. The first step is referred to as a “cleaning and sterilizing step.”

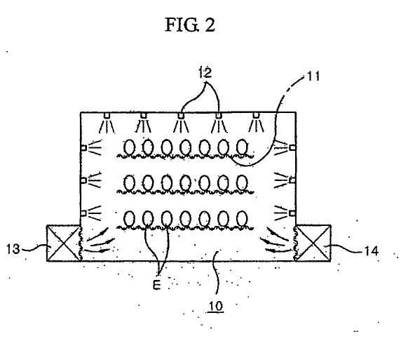

FIG. 2 illustrates schematically the first step of cleaning and sterilizing a raw egg in the method of the invention. Referring to FIG. 2, a plurality of raw eggs E is arranged on a screen 11 of a cleaning and sterilizing chamber 10 and cleaned by a salt water forcefully sprayed through a nozzle 12.

The cleaning water, i.e., the salt water is harmless to the human body and has a characteristic of suppressing the multiplication of the Escherichia coli.

The cleaning water passes through the screen 11 on which the raw eggs E is placed, and flows downwards to thereby clean other raw eggs placed on the lower screens 11

On completion of the cleaning process, a cold air blower 13 and an ozone generator 14 are operated in order to blow a cold air and an ozonized air inside the cleaning and sterilizing chamber 10.

The cold air blown to the raw egg E has a temperature of 0-1° C. such that the cleaning water remaining on the surface of the raw egg E can be dried.

In case where the drying air is heated-up, for example, the raw egg E may be rotten or damaged while carrying out the first step. Therefore, a cool cold air is used in order to dry the cleaning water remaining on the surface of the raw egg E.

In addition, an ozonized air is blown into the cleaning and sterilizing chamber 10 during the process for drying the raw egg E, thereby simultaneously carrying out a sterilizing process. The ozonized air is commonly used for disinfecting various bacteria, and thus detail thereon will not be described herein.

The quantity of ozonized air, which is blown into the cleaning and sterilizing chamber 10, is very small on the order of 4 mg/l per one hundred of raw eggs, so that it is harmless to the human body. The result of an experiment, where 4 mg/l of ozonized air per 100 eggs is contacted with the raw eggs for 15 minutes, it has been found that Escherichia coli is disinfected from 3,000 into less than 10. When contacted for 20 minute, Escherichia coli is found out to have been disinfected into less than 2.

Therefore, the quantity of ozonized air required to be blown into the cleaning and sterilizing chamber 10 is calculated in proportion to the number of raw eggs E inside the chamber and blown thereinto for 20 minutes. Then, Escherichia coli harmful to the human body is sterilized, along with Salmonella, Staphylococcus, enteritis vibrio, and the like.

The above cleaning and sterilizing step of raw eggs E is for the purpose of hygienic treatment for the whole process of the invention. Also, the cleaning and sterilizing step serves to prevent bacteria from penetrating the inside of the raw egg E during the subsequent third step of drilling the egg-shell.

The second step is a process for solidifying the albumen surface of a raw egg.

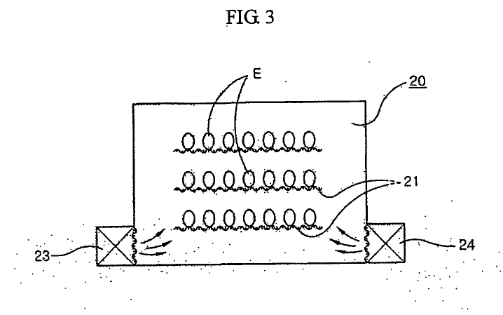

Referring to FIG. 3, in the albumen surface solidifying step, a plurality of raw eggs E is placed on a screen 21 inside the a humidifying and heating chamber 20 and heated for 5˜8 minutes by blowing an air heated to 60˜65° C. using a heater 22. At this time, the raw egg E is prevented from drying by flowing moisture into the humidifying and heating chamber 20 using a humidifier 23, or by installing the humidifier 23 inside the humidifying and heating chamber 20.

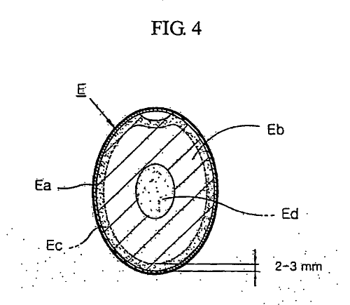

While the second step is carried out, the egg shell Ea of the raw egg E starts to be heated and then the albumen Eb is progressively boiled inwards of the egg-shell Ea, as shown in FIG. 4, which is a cross-section of a raw egg processed by the second step.

When the second step is finished, the raw egg E is process such that the albumen Eb is boiled and cooked by a thickness of 2˜3 mm inwards of the egg-shell Ea to thereby form a solidified albumen skin layer Ec (the dotted area in FIG. 4). The albumen Eb and the yolk Ed inside the solidified albumen skin layer Ec remain in a semi-solid state.

By reference, in order for a raw egg to be well-done, it must be boiled at 80˜85° C. or higher for more than 12 minutes. In the second step of the invention, the raw egg is heated at 60˜65° C. for 5˜8 minutes such that the surface area of the albumen Eb in the proximity of the egg-shell Ea is done to thereby form the solidified albumen skin layer Ec.

When the albumen Eb of semi-liquid state and the yolk Ed are agitated, the solidified albumen skin layer Ec is not agitated and remains in the solidified state. Therefore, when the raw egg is well done (fully boiled) and the egg-shell Ea (crust) is removed, the original color of the albumen Eb (white color) is exhibited.

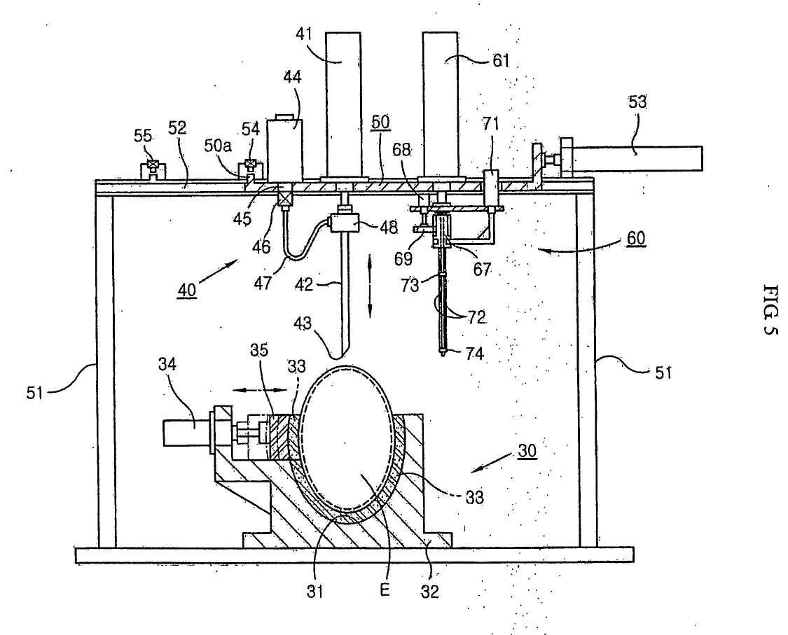

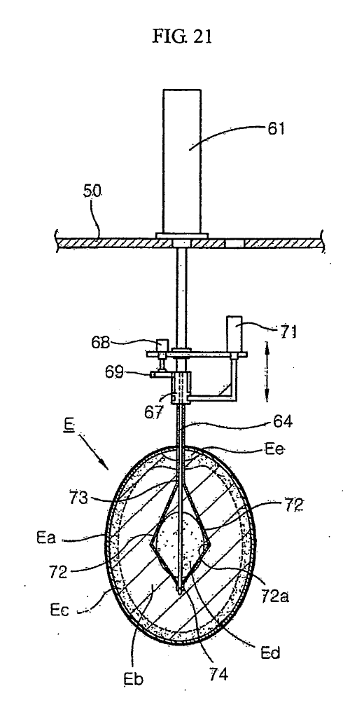

The third step is an egg-shell drilling process, the fourth step is an edible composition injection process, and the fifth step is a raw egg agitating process, as illustrated in FIGS. 5 to 21. The second to fifth steps are continuously and automatically carried out.

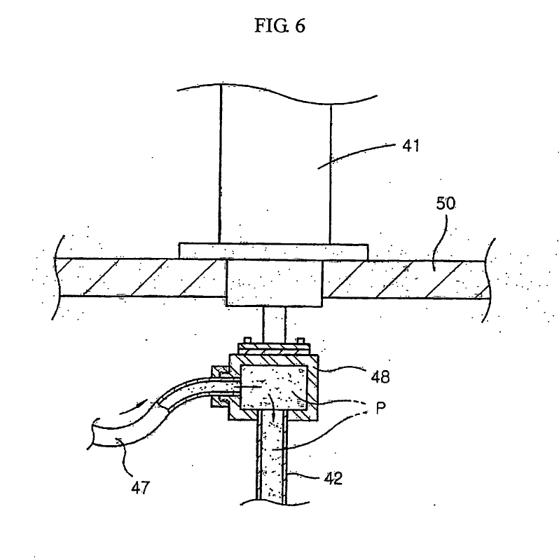

Referring to FIGS. 5 and 6, the third and fourth steps, the egg-shell drilling process and the edible composition injection process are described hereafter.

Referring to FIG. 5, the apparatus of the invention is provided with a raw-egg holding means 30 for fixing the raw egg E.

The raw egg holding means 30 is provided with a fixed member 32 having a resting groove 31, to which the raw egg can be inserted and rested. The resting groove 31 has a tough and buffering protection member 33 attached to the inner face thereof.

In addition, a pressurizing cylinder 34 is mounted on one side face thereof. The pressurizing cylinder 34 is operated such that a pressurizer 35 presses one side face of the raw egg E so as not to be moved.

Therefore, the pressurizing cylinder 34 is operated in such a manner that the pressurizer 35 moves backwards in order for a raw egg E to be rested on the resting groove 31, and thereafter moves forwards pressurizes the raw egg E.

At this time, the protection member 33 serves as a buffer so that the raw egg is not broken, in spite of a slightly difference size of eggs.

The raw egg is held in the raw egg holding means 30 in such a way that the elongated portion of the raw egg is oriented upwards.

The raw egg E held and fixed in the raw egg holding means 30 is drilled in its egg shell Ea and injected with an edible composition P by means of a drilling and injection means 40.

The drilling and injection means 40 is provided with a drilling and injection tube 42, which is descended and ascended vertically by the operation of a pressurizing cylinder 41 fixed to a main plate 50. The drilling and injection tube 42 is provided with a pointed needle 43 at the end thereof, and has a diameter of 2 mm.

At one side of the pressurizing cylinder 41, a composition tank 44 is fixed to the main plate 50. In the outlet 45 of the composition tank 44 is installed a quantified discharging pump 46 for pressure-transferring the edible composition P.

The quantified discharging pump 46 is constructed such that the edible composition P discharged therefrom is pressure-transferred into the drilling and injection tube 42 through a pressure-transferring hose 47 via an intermediate station 48, which is installed above the drilling and injection tube 48 (refer to FIG. 6).

The operation of the egg-shell drilling and injection means 40 will be explained below. Details on the edible composition P will be described hereinafter.

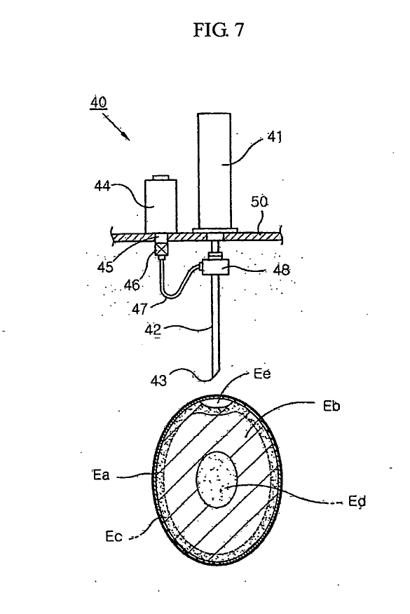

At the initial state of the egg-shell drilling and injection means 40, the drilling and injection tube 42 is placed above the raw egg E, as illustrated in FIG. 7.

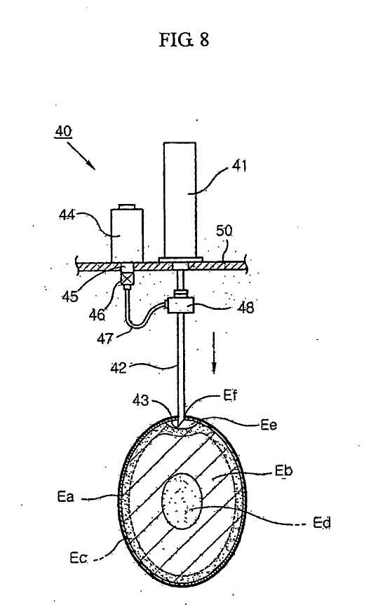

At this state, the pressurizing cylinder 41 is operated to descend the drilling and injection tube 42 slowly to reach the egg-shell Ea, as illustrated in FIG. 8.

Since the pressurizing cylinder 41 must be operated slowly, it is preferred to be a hydraulic cylinder, and it has been found out that a pressure of 3˜5 kg/cm² should be exerted to the egg-shell Ea in order to form a hole therein.

In addition, the raw egg is erected in a longitudinal direction, and thus an injection hole Ef can be formed without breaking the egg, due to the resistant force of the egg-shell against the pressurizing force.

The area where the injection hole Ef is formed is slightly depressed, but can be disregarded, and thus does not affect significantly the commercialization of the egg.

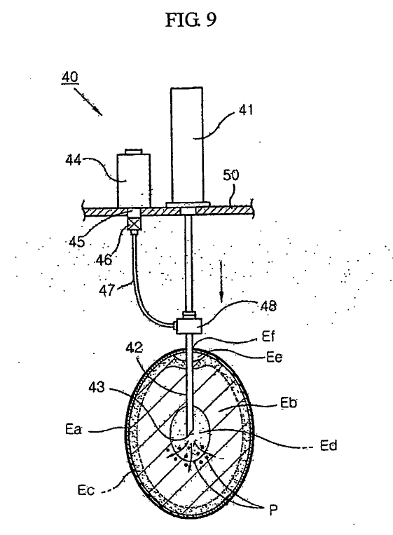

Therefore, the drilling and injection tube 42 is inserted into the central portion of the raw egg E and then the third step, i.e., the egg-shell drilling process is completed, as shown in FIG. 9.

Next, the fourth step of edible composition injection process is carried out. In the edible composition injection process, at the state of FIG. 9, the quantified discharging pump 46 is operated to inject a quantified amount of edible composition P into the inside of the yolk Ed and the albumen Eb of semi-liquid state through the drilling and injection tube 42.

On the other hand, the edible composition P is formed of a liquid composition with a small amount of powder mixed therewith, and the amount of the edible composition P is less than 10 volume % of the entire volume of the raw egg.

When the injection of the edible composition P is finished, the pressurizing cylinder 41 is reverse-operated to lift the drilling and injection tube 42, which is released from the raw egg E and returned to the initial state as in FIG. 9. These operations are continuously and automatically performed by means of a controller (not shown).

Since the solidified albumen skin layer Ec has a flexibility, it is contracted when the drilling and injection tube 42 is escaped from the raw egg E, so that the it can be shut down from an external air and also the albumen of semi-liquid is not leaked to the outside thereof.

On the other hand, the edible composition P used in the invention is formed of a liquid composition with a little powder mixed therewith. Here, the constituents of the edible composition are described below, and the effect therefor will be hereinafter explained.

That is, the edible composition P is comprised of edible and inter-mixable constituents selected from all the natural and processed materials. The constituents do not cause any harmful chemical reaction with one another, and include brown rice, bean paste, garlic, anion, kelp, powdered pyogo mushroom, sesame oil, perilla oil, fine leaf extract, dropwort extract, propolis, grape seed oil, vinegar, basil, peppermint, chervil, lavender, salt, sugar, grains, fruits, nuts, fishes, shells, vitamin C, spices, pigment, and the like. Among the above constituents, the salt and sugar may be in a liquid or powder form. The salt or sugar is a basic constituent, which is added to all kinds of edible compositions P in the invention.

Several examples for the constituents and contents of the edible composition P will be illustrated below. The contents thereof are based on the volume of the raw egg E.

Here, a chicken egg is used as the raw egg.

### EXAMPLE 1

An edible composition P comprises brown rice 2 volume %, bean paste 1 volume %, garlic 1 volume %, onion 1 volume %, kelp 1 volume %, powdered pyogo bushroom 1 volume %, sesame oil 1 volume %, salt 1 volume %, and sugar 1 volume %.

### EXAMPLE 2

An edible composition P comprises pine leaf extract 2 volume %, perilla oil 1 volume %, salt 1 volume %, and sugar 1 volume %.

### EXAMPLE 3

An edible composition P comprises dropwort extract 3 volume %, perilla oil 1 volume %, salt 1 volume %, and sugar 1 volume %.

### EXAMPLE 4

An edible composition P comprises propolis 1 volume %, grape seed oil 1 volume %, salt 1 volume %, and sugar 1 volume %.

### EXAMPLE 5

An edible composition P comprises vinegar 2 volume %, grape seed oil 1 volume %, salt 1 volume %, and sugar 1 volume %.

### EXAMPLE 6

An edible composition P comprises basil 2 volume %, grape seed oil 1 volume %, salt 1 volume %, and sugar 1 volume %.

### EXAMPLE 7

An edible composition P comprises peppermint 1 volume %, grape seed oil 2 volume %, salt 1 volume %, and sugar 1 volume %.

### EXAMPLE 8

An edible composition P comprises chervil 2 volume %, grape seed oil 1 volume %, salt 1 volume %, and sugar 1 volume %.

### EXAMPLE 9

An edible composition P comprises lavender 2% volume, grape seed oil 1 volume %, salt 1 volume %, and sugar 1 volume %.

The fifth step is carried out in the raw egg E, to which an edible composition P is injected. The fifth step is performed through an agitating means 60 and will be described below.

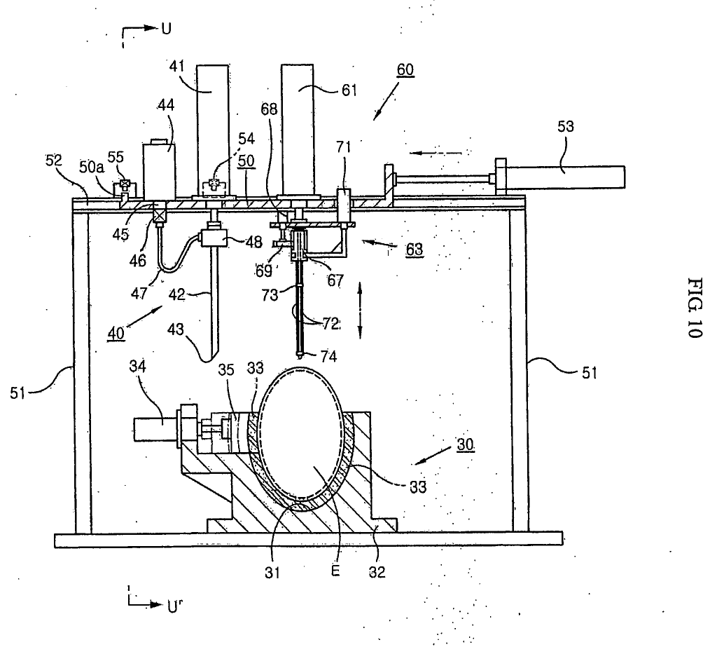

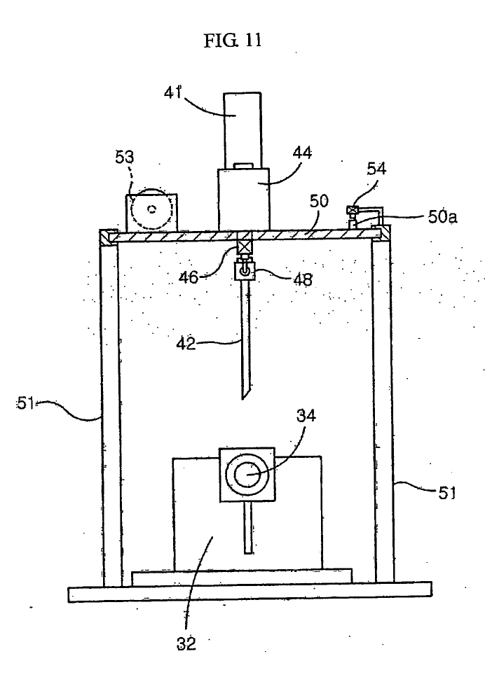

Referring to FIGS. 10 and 11, the main plate 50 is constructed so as to move along a guide rail 52 fixed on the support frame 51. The movement of the main plate 50 is carried out by a reciprocating cylinder 53 installed in one side thereof.

Therefore, after the raw egg E is processed through the egg-shell drilling and injection means 40, the reciprocating cylinder 53 is operated to move the main plate 50 in order for the agitating means 60 to be moved and held above the raw egg E.

This moving and holding operation is carried out in such way that a controller (not shown) controls the operation of the reciprocating cylinder 53 when a dog 50a provided in the main plate 50 approaches a first and second sensor 54 and 55.

That is, when the operation of the egg-shell drilling and injection means 40 is finished in the third and fourth steps, according to the instructions of the controller, the reciprocating cylinder 53 is operated to move the main plate 50 such that the dog 50a approaches the second sensor 55.

Therefore, the second sensor 55 sends a signal to the controller, and the controller stops the movement of the reciprocating cylinder 53 according to the signal.

In addition, when the operation of the agitating means 60 is finished in the fifth step, the controller controls the reciprocating cylinder 53 such that the main plate 50 returns to its original position. At this time, when the dog 50a approaches the first sensor 54, a signal is applied to the controller to stop the operation of the reciprocating cylinder 53.

The operation of the apparatus of the invention required for the manufacturing process of the invention is configured so as to be controlled by a controller. The control technique is well known, and thus details on the controller will not be described here.

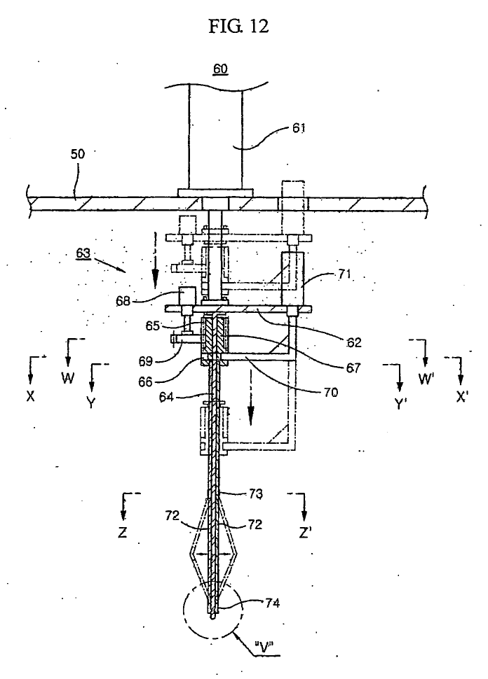

Referring to FIGS. 12 to 18, the agitating means 60 for carrying out the fifth step of the invention will be explained below.

Referring to FIGS. 12 to 14, in the agitating means 60, an ascending and descending cylinder 61 is 5 installed in the main plate 50, and a driving device 63 including a support member 62 descends or ascends by means of the ascending and descending cylinder 61.

In the driving device 63, a long support axle rod 64 is fixed to the center of the support member 62, and a free-rotating member 67 having a gear 65 and a rotating groove 66 is rotatably installed in the upper portion thereof.

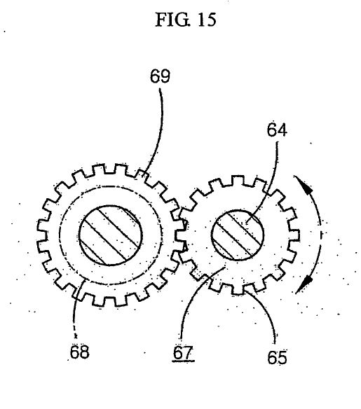

The gear 65 of the free-rotating member 67 is engaged with a driver gear 69, which is rotated by a reciprocal motor 68, as shown in FIG. 15. Therefore, the fee-rotating member 67 is constructed so as to rotate in forward and reverse directions by a rotating power transferred from the reciprocal motor 68.

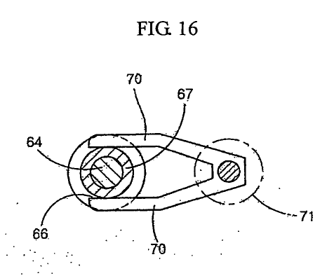

In addition, an ascending and descending member 70 is inserted into the rotating groove 66 of the free-rotating member 67, as shown in FIG. 16. The ascending and descending member 70 is constructed such that it can move upwards and downwards by the operation of a moving cylinder 71 fixedly installed in the support member 62.

Therefore, as the ascending and descending member 70 moves upwards or downwards, the free-rotating member 67 moves upwards or downwards along the support axle rod 64.

In addition, the gear 65 is elongated vertically and thus the free-rotating member 67 can move upwards and downwards at the engaged state with the driver gear 69. Also, when the downward movement of the free-rotating member 67 is completed and held in place, the free-rotating member 67 can be rotated in a forward or reverse direction by the driver gear 69, which is rotated by the rotation of the reciprocal motor 68.

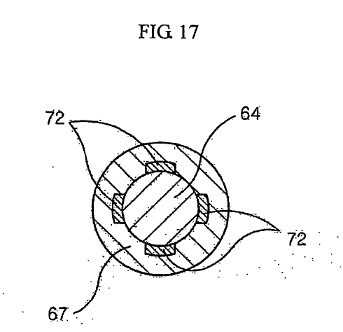

On the other hand, a plurality of rotating member 72 (for example, four rotating members) is fixed to the lower end portion of the free-rotating member 67 in such a manner that the rotating members 72 is rotated by the rotation of the free-rotating member 67 (refer to FIG. 17). The rotating member 72 may be fixed by using the argon welding, the spot welding, or the like.

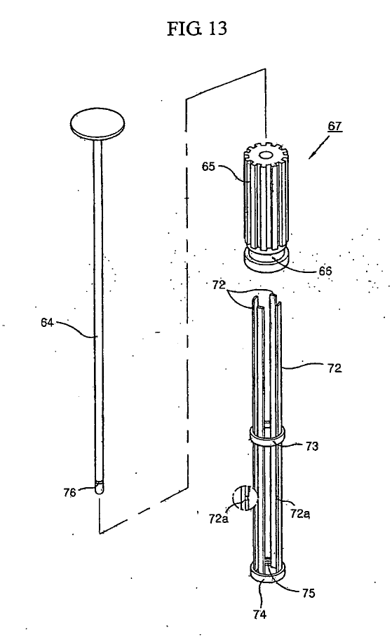

Furthermore, the rotating member 72 has a thin thickness on the order of 0.6 mm and is formed of a piano wire or stainless steel having a good resilience. As shown in FIG. 13, the rotating member 72 is provided with a bending groove 72a formed in the inner side of the intermediate portion thereof so as to be easily bent.

The rotating member 72 is closely contacted with the outer circumferential surface of the support axle rod 64, and a ring 73 is inserted at the middle of thereof and fixed thereto by a welding and the like.

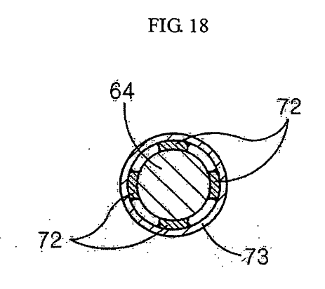

Therefore, the ring 73 rotates as the rotating member 72 rotates on the circumferential surface of the support axle rod 64 (refer to FIG. 18).

A free-rotating ring 74 is inserted into the lower end portion of the rotating member 72 and fixed thereto by a welding or the like.

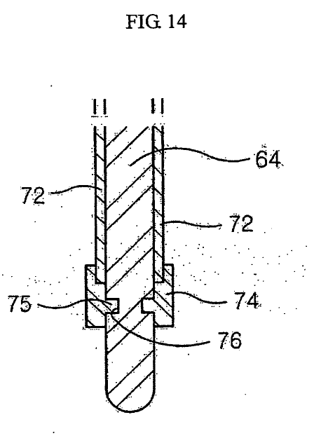

As shown in FIG. 14, a rotating projection 75 is formed in the inner circumferential surface. The rotating projection 75 is rotatably inserted into a guide groove 76 of the support axle rod 64. The entire diameter of all the support axle rod 64, the rotating groove 71 and the free-rotating ring 74 is such that they can be inserted through the injection hole Ef formed in the upper end portion of the raw egg E.

Therefore, the free-rotating ring 74 is rotated by the rotation of the rotating member 72, but does not move upwards and downwards along with the support axle rod 64 since the rotating projection 75 is rotatably inserted into the guide groove 76.

Referring to FIG. 12, the operation of the agitating means 60 will be described below.

At the initial state of the agitating means 60, the driving device 63 is placed above as shown in an imaginary line.

In this state, the ascending and descending cylinder 61 is operated such that the driving device 63 is moved downwardly as shown in a solid line.

Next, the moving cylinder 71 is operated such that the free-rotating member 67 is moved downwardly as shown in an imaginary line. At this time, the rotating member 72 is descended since the upper end portion thereof is fixed to the free-rotating member 67.

However, since the rotating member 72 rotates only at its lower end portion and the free-rotating ring 74 connected so as not to move up-and down is fixed to the rotating member 72, the lower end portion of the rotating member 72 does not descend and only its upper end portion descends. Therefore, that portion of rotating member 72 between the ring 73 and the free-rotating ring 74 is bent outwardly as depicted in an imaginary line.

At this state, when the reciprocal motor 68 is operated, its driving power rotates the free-rotating member 67 via the driver gear 69, and thus the rotating member 72 rotates about the support axle rod 64.

The returning operation to its original state is carried out in a reverse order of the above-described operation.

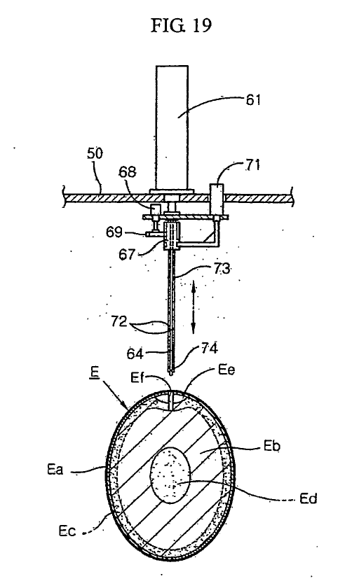

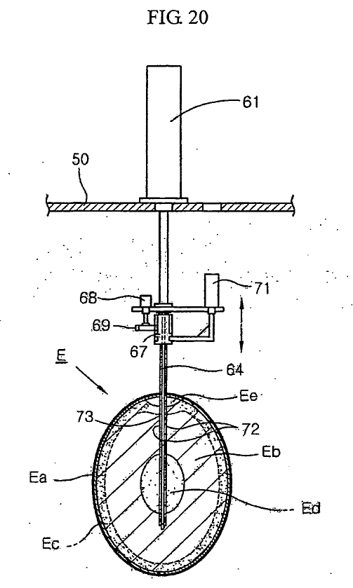

FIGS. 19 to 21 show the operation of the agitation means 60 to perform the fifth step of agitating a raw egg. FIG. 19 shows the initial state thereof, and FIG. 20 shows the state where the support axle rod 64 and the rotating member 72 are inserted into the injection hole Ef of the raw egg E.

Therefore, at the above state, the rotating member 72 is spread sideways to form an impeller-like shape.

In this state, the reciprocal motor 68 is operated to rotate the rotating member 72 such that the semi-liquid albumen Eb, the yolk Ed, and the edible composition P are agitated and mixed. If a solidified albumen skin layer Ec is formed, it remains unmixed, not being agitated by the rotating member 72.

In the above-described embodiment, an agitating means, which is spread in an impeller form and rotated, is illustrated, but the present invention is not limited thereto. For example, an agitating means may be injected in a rod form and spread in various forms, and moves upwards and downwards or rotate in order to agitate the contents inside the raw egg.

On the other hand, when the raw egg is agitated and well-done, the salt and sugar contained in the edible composition P play an important role. That is, the major constituent of the albumen Eb and the yolk Ed is an alkaline protein. Here, if the salt, which is an inorganic salt, is contained, it becomes an electrolyte, which adsorbs an ion having an opposite electric charge, so that an electrical neutralization is achieved, thereby enabling an easy solidification when carrying out a well-done cooking. Also, in a state of a raw egg, when the conalbumin among the proteins of the albumen is bonded with a metallic ion such as Na of the salt NaCl, the internal bonding of the protein is cut, thereby increasing its activity.

That is, the salt serves to decrease the viscosity during agitating the mucus albumen Eb and the yolk Ed, so that the edible composition P is mixed more thoroughly.

In addition, even with the same raw egg, the albumen Eb and the yolk Ed exhibit a different solidifying temperature and solidified state when well-done. That is, when the raw egg is heated up slowly from a low temperature, it becomes soft. Heating fast at a higher temperature is likely to generate porosity. Furthermore, the solidification capacity of a raw egg E is affected by other materials. When sugar is contained in the raw egg, it absorbs sucrose contained in the protein of raw egg so that the solidification temperature of the raw egg E is increased. That is, the sugar slows down the heat transformation of protein and thus impedes its solidification, thereby resulting in a soft well-done egg.

Resultantly, the salt functions to lower the viscosity of the mucus albumen Eb and the yolk Ed so that they can be smoothly mixed with the edible composition P. The sugar serves to enable the well-done egg to be soft and provide flavor.

As described previously, salt and sugar to be added to the edible composition P may be added in a liquid form or in a powder form. In addition, the above-described embodiment does not exclude other additives, which serves to perform the same as or similar role to the salt and the sugar.

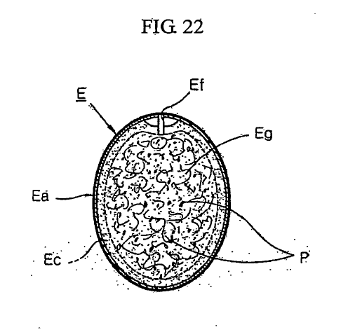

On completion of the fifth step (agitating process) of the invention, as shown in FIG. 22, the sixth step (well-done process) is carried out to solidify the mucus contents Eg, which is inter-mixed excepting the solidified albumen skin layer Ec. This process may be performed by boiling the raw egg, smoking the raw egg, or steaming the raw egg to thereby make a well-done egg. These processes are well known, and thus details thereon will not be described here.

Alternatively, other than the heating and solidifying of raw egg, Pidan process (Pidan: a processed blackish duck egg used for Chinese cooking), which is known from Taiwan or Southwestern China, or its applications can be used for chemically solidifying a raw egg using the solidifying property of alkaline. Pidan is made using a duck egg, but many examples using a chicken egg are known. Accordingly, the chemical solidification method can be applied to all kinds of raw eggs. In case of Pidan, a paste containing salt, lime or the like is coasted on the egg-shell such that the alkaline constituent and salt can be permeated through micro pores of the egg-shell. It based on the principle that, since protein is charged negatively usually under the circumstance of above PH 7, it is solidified when a material having an opposite electrical charge to the protein is applied thereto.

According to the invention, when the egg-shell Ea is peel off from the well-done egg manufactured as described above, the solidified albumen skin layer Ec having a white color is exposed, and thus provides the same feeling as in eating a generally well-done egg, thereby enabling to eat it without reluctant feeling.

On the other hand, according to another embodiment of the invention, the second step may be omitted, and therefore, a solidified albumen skin layer is not formed, instead the albumen and the yolk are mixed and agitated. In this case, when the egg-shell is removed from a well-done egg, the color of the edible composition or a color of any edible pigment is appeared, and thus can draw the user's curiosity and interests.

Furthermore, according to another embodiment of the invention, the second step and the sixth step (solidification process) may be omitted, and thus a raw egg with an edible composition mixed and agitated thereinside can be provided.

On the other hand, the above-described manufacturing apparatus may be provided with an additional suction pump and/or suction tube for suctioning the yolk. Before the edible composition injection process, at least of the raw egg contents including the albumen and the yolk is removed and instead the same amount of grains containing a carbohydrate such as rice, barley, glutinous rice, brown rice, or the like can be injected and agitated. In stead of providing an additional suction pump, the quantified discharging pump is reverse-operated to remove part of or the entire of the raw egg contents. The grain may be injected together with an edible composition, or the grain alone may be injected.

Alternatively, part of the raw egg contents is removed, but part of or the entire of the yolk remains. Then, fruit constituent can be injected and agitated in a powder form or in a liquid extract form, along with Calcium or an edible material containing Calcium (for example, diary product such as milk, bean, green vegetable, seaweed, fish bone). In this case, a raw egg pudding can be made by means of the inter-mixing of the fruit constituent, Calcium and the yolk.

As described above, each of the edible compositions is produced by adding at least one edible additive, each of which has a certain nutrients and efficacy. The efficacy of the edible composition examples illustrated in the embodiments of the invention will be described below.

The first example of the edible composition P, which comprises brown rice 2 volume %, bean paste 1 volume %, garlic 1 volume %, onion 1 volume %, kelp 1 volume %, powdered pyogo mushroom 1 volume %, sesame oil 1 volume %, salt 1 volume %, and sugar 1 volume %, can be mixed and agitated. Among the above constituents, the brown rice has an efficacy, including facilitation of metabolism such as fatigue relief and fatness alleviation, enhancement of brain cell metabolism, blood pressure depressant, kidney activation, liver function enhancement, fatness prevention, energy metabolism acceleration. Also, it has an efficacy in menopausal disorder, feeling of helplessness caused by autonomic ataxia imbalance, headache, insomnia, feeling of fatigue, shoulder pain, dizziness, or the like.

In addition, it is well known that the bean paste has an efficacy of neutralizing toxins from meats, vegetables, mushrooms, insect, and the like, enhancing appetite, and facilitating digestion, and has an excellent anti-cancer effect. It also has an efficacy in headache alleviation, protection of high-blood pressure, and facilitation of liver function.

The garlic has an efficacy in lowering blood pressure, heart disease, sclerosis of the arteries, facilitation of digestion, constipation, diarrhea, prevention of flu, diabetes, nephritis, fatigue relief, enhancement of stamina.

The onion has an efficacy in dropping blood pressure, facilitation of digestion, stomach ulcer, and diabetes, and the kelp has an efficacy in constipation, skin aesthetics, diet, and an efficacy of impeding or controlling absorption of fat, cholesterol, excessive salt, heavy metals and harmful substances.

The pyogo mushroom is a low calorie constituent and abundant in various minerals and vitamins. It has an effect of preventing obesity, diabetes, heart disease, liver disease, or the like by adjusting the function of stomach and small intestine due to a constituent called hemi-cellulose. Also, it has an efficacy in anti-cancer, anti-virus, prevention of anemia and sclerosis of the arteries, and alleviating high blood pressure and cholesterol.

The sesame oil has an efficacy in lowering blood pressure, sclerosis of the arteries, constipation, enhancement of robustness and stamina, and the like. The perilla oil prevents sclerosis of the arteries, lowers the level of cholesterol, has an excellent effect of preventing carcinoma of large intestine, and has an efficacy of disinfecting the bite of poisonous insects.

The salt adjusts flavor and facilitates agitation, and the sugar serves to smoothly solidify the protein of raw egg during its solidification.

In case of the second example of edible composition, which comprises pine leaf extract 2 volume %, perilla oil 1 volume %, salt 1 volume %, and sugar 1 volume %, a well-done egg having a good aroma can be obtained. The pine leaf extract has an effect and efficacy in liver disease, intestine disease, nervous disease, skin protection, prevention of paralysis, strengthening of stomach, blood nourishment, prevention of aging-related disease such as sclerosis of the arteries, high blood pressure, and diabetes. Details on the perilla oil, salt, and sugar are described above and thus will not be repeated.

Therefore, the well-done egg agitated with the edible composition of the second example is suitable as a healthy food for people who like pine aroma.

The third example of edible composition comprises dropwort extract 3 volume %, perilla oil 1 volume %, salt 1 volume %, and sugar 1 volume %. Its main constituent, the dropwort has a good effect and efficacy in stopping bleeding (hemostatic effect), high blood pressure, jaundice, influenza, alleviation of fever, tranquility, alcoholic poisoning, pneumonia, menstrual irregularity, sunstroke, robustness of stamina, acute and chronic inflammation of liver, cirrhosis of the liver, nourishment of blood, and constipation. It is suitable as a healthy food for people who need this efficacy.

In case of the fourth example of edible composition, which comprises propolis 1 volume %, grape seed oil 1 volume %, salt 1 volume %, and sugar 1 volume %, the bioflavonoid contained in the propolis activates generation of interferon by stimulating leucocyte and limp sites, thereby providing an amazing resistance against diseases. The grape seed oil has a good efficacy in anti-oxidation, enhancement of skin smoothness and resilience, strengthening of capillary vessel, artery and vein, suppression of inflammation enzyme, enhancement of joint flexibility, and restoration of deteriorated memory, thereby providing a good healthy food for people who have a week resistance against diseases.

In the fifth example of edible composition, which comprises vinegar 2 volume %, grape seed oil 1 volume %, salt 1 volume %, and sugar 1 volume %, the vinegar suppresses synthesis of fat and decomposes fat to thereby prevent accumulation of fat, activate metabolism in the interior of the body, and provide a good efficacy in constipation. The grape seed oil has the efficacy as described above. Therefore, this example of edible composition is suitable for a city-dweller's healthy food.

The sixth example of edible composition P comprises basil 2 volume %, grape seed oil 1 volume %, salt 1 volume %, and sugar 1 volume %. The basil has an efficacy in rheumatism, hypersensitivity, headache, stomatitis, and robustness. Therefore, along with the efficacy of the grape seed oil, it can be a good healthy food for elderly and weak people.

In the case of the edible composition of the seventh example, which comprises peppermint 1 volume %, grape seed oil 2 volume %, salt 1 volume %, and sugar 1 volume %, the peppermint has an efficacy in increasing blood pressure, strengthening of stomach, prevention of flu, headache, toothache, neuralgia, and alleviation of fever. Therefore, along with the efficacy of the grape seed oil, it provides a good healthy food.

The eighth example of edible composition comprises chervil 2 volume %, grape seed oil 1 volume %, salt 1 volume %, and sugar 1 volume %. The chervil contains lots of vitamin C, carotin, magnesium and has an efficacy in lifeblood, urination, facilitation of digestion, rheumatism, improvement of skin. Therefore, it provides a diet healthy food for women.

The ninth example of edible composition comprises lavender 2 volume %, grape seed oil 1 volume %, salt 1 volume %, and sugar 1 volume %. The lavender has a good effect for rheumatism, arthritis, and has an efficacy in bronchitis, allergic rhinitis, gastric ulcer, duodenal ulcer, and heart diseases. Along with the efficacy of the grape seed oil, it can provide a healthy food for elderly people.

In the above-described examples, the content of each additive can vary under the condition that the edible composition is within 10% of the whole raw egg (in volume). For example, although the ninth example includes lavender 2 volume %, grape seed oil 1 volume %, salt 1 volume %, and sugar 1 volume %, it may comprise lavender 1 volume %, grape seed oil 1.5 volume %, salt 0.7 volume %, and sugar 0.5 volume %.

In addition, besides the additives as described above, meats, marine products, vegetables, various seasonings, spices, or the like can be contained. Along with the natural materials, processed materials such as vitamin or the like can be added. The raw egg with the edible composition injected thereinto exhibits the inherent flavor and aroma, and color of the additives. The color, flavor, and aroma thereof can be freely adjusted and selected by edible pigments and spices.

On the other hand, the raw eggs processed according to the features of the invention can be provided to each individual user in various forms. For example, it may be provided in the form of raw egg with an edible composition agitated therewith, or a solidified form heated or chemically solidified after agitating. Also, after removing the egg-shell from a solidified egg, it may be contained in a packing container made of vinyl or plastic material before served.

The raw eggs processed according to the invention are rather necessary in the modern society. That is, what is called “hidden starvation” is known in the modern world of the science of nutrition. This “hidden starvation” is resulted from inadequate intake of healthy nutrients such as vitamin, minerals, or protein. In many cases, people are not aware that he or she suffers from this starvation because they have quantitatively adequate meals. Occasionally, this starvation occurs to people who are confident that they are taking qualitatively good meals. Therefore, this kind of starvation is more dangerous and more likely to be harmful to health. Currently, the academic world reports that this starvation is of significance in this country.

The present invention becomes one approach to easily solve this hidden starvation. It is because the raw egg according to the invention has an edible composition including various nutrients and can be easily taken. In particular, the well-egg of the invention exhibits the white of an egg even when the egg-shell is removed, so that it can be in-taken without a feeling of reluctance. Also, it may be processed such that without the white of an egg, it has various colors, flavors, and aromas, so as to meet various preferences of people, including elderly people, patients, adults, children, and men and women. Consequently, the raw egg of the invention can be served as an excellent favorite food, a nourishing meal, or a healthy food.

### INDUSTRIAL APPLICABILITY

As described above, according to the present invention, an edible composition is injected into the inside of a raw egg and agitated adequately, so that the edible composition is distributed over the whole area, but not localized in a certain area inside the white of the egg. Therefore, its commercializing value of the eggs can be increased. Also, the raw eggs can be served as a healthy food or nourishing meal.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A method of manufacturing a processed raw egg having an edible composition agitated therewith, the method comprising:
a) a cleaning and sterilizing step of cleaning an raw egg E with a cleaning water and sterilizing it;
b) an egg-shell drilling step of forming an injection hole Ef in the upper portion of the egg-shell Ea of the raw egg E, wherein the raw egg E is fixedly erected and a certain pressure is exerted on the upper portion of the long axis of the raw egg by means of a drilling and injection tube 42 such that the injection hole is formed;
c) an edible composition injection step of injecting a predetermined amount of edible composition P by penetrating the drilling and injection tube 42 inside the raw egg E through the injection hole Ef of the raw egg E; and
d) a raw egg agitation step of agitating the edible composition P and the viscous albumen Eb and yolk Ed using an agitating means inserted through the injection hole Ef of the raw egg E.

2. The method according to claim 1, wherein the raw egg agitation step is carried out by agitating the content of the raw egg and the edible composition, wherein the agitating means is inserted into the inside of the raw egg in the form of a rod, spread, and then moves upwards and downwards and/or rotates.

3. The method according to claim 1, before the egg-shell drilling step, further comprising a solidified albumin skin layer forming step of forming a solidified albumen skin layer Ec having a certain thickness, wherein the raw egg E is heated such that a certain thickness of albumen Eb inwards of the egg shell Ea is solidified, and after the raw egg agitation step, further comprising a solidification step for solidifying the raw egg by means of a heat-up or a chemical reaction.

4. The method according to claim 1, before the edible composition injection step, further comprising steps of:
a) suctioning and removing at least part of the content of the raw egg including the albumen and the yolk by injecting a suction tube up to the yolk portion of the raw egg; and
b) injecting grains or fruits including carbohydrate into the place where the content of raw egg is removed in the suctioning and removing step.

5. An apparatus for manufacturing a processed raw egg having an edible composition agitated therewith, the apparatus comprising:
a) a raw egg holding means 30 including a resting groove 31 for an raw egg to be rested thereon and a pressurizer 35 for pressurizing one side of the raw egg E;
b) a drilling and injection tube 42 for forming an injection hole Ef in the upper end portion of the raw egg E;
c) a drilling and injection means 40 for injecting an edible composition P into the interior of the raw egg, the drilling and injection means including a quantified discharging pump 46 and the drilling and injection tube 42; and
d) an agitating means 60 for agitating the internal material of the raw egg, the agitating means being injected in the form of a rod and afterwards spread, and moving upwards and downwards and/or rotating.

6. The apparatus according to claim 5, wherein the agitating means 60 comprises a support and axle rod 64 injected by an ascending and descending cylinder 61 through the injection hole Ef of the raw egg E, and a free-rotating member 67 provided in the upper portion of the support and axle rod 64 and adapted to be rotated by the power of a reciprocal motor 68 and descended and ascended by a moving cylinder 71, a plurality of rotating members 72 rotatably installed in the lower end portion of the support and axle rod 64 so as to be rotated about the support and axle rod 64, the rotating member 72 being fixed at an upper end portion thereof to the free-rotating member 67 and at a lower end portion thereof to a free-rotating ring 74, and a ring 73 fixedly installed in the intermediate portion of the rotating member 72 such that the portion of rotating member 72 between the ring 73 and the free-rotating ring 74 is spread outwardly as the rotating member 67 descends.

7. The apparatus according to claim 5, further comprising a suction pump and a suction tube for suctioning and removing at least part of the content of the raw egg.

8. A processed raw egg having an edible composition agitated therewith, wherein a certain desired amount of edible composition is injected through an injection hole formed in the upper portion of the long axis of a raw egg, and the injected edible composition and the contents of the raw egg are agitated by an agitating means, the agitating means being inserted in the form of a rod, spread in a desired form, and moved inside the raw egg.

9. The processed raw egg according to claim 8, wherein a certain thickness of the albumen Eb inwards of the egg-shell Ea is solidified before injection the edible composition.

10. The processed raw egg according to claim 8, wherein the total amount of the injected edible composition is within 10 volume % of the raw egg.

11. The processed raw egg according to claim 8, wherein the edible composition contains at least one of a natural edible material, a processed nourishing material such as vitamin, an edible pigment, and an edible spices.

12. The processed raw egg according to claim 8, wherein a part of the content of the raw egg including the albumen and the yolk is removed, and grains including carbohydrate and fruits are added thereto.
